(19) United States
(12) Patent Application Publication
(10) Pub. No.: US 2004/0047503 A1
(43) Pub. Date: Mar. 11, 2004

(54) Method for selecting similar colors, and associated computer system

(76) Inventors: Torsten Derr, Dormagen (DE); Jurgen Monnerjahn, Neuss (DE); Ulrich Scheper, Dormagen (DE)

Correspondence Address: BAYER POLYMERS LLC, 100 BAYER ROAD, PITTSBURGH, PA, 15205, US

(21) Appl. No.: 10/614,707

(22) Filed: Jul. 7, 2003

(30) Foreign Application Priority Data
Jul. 11, 2002 (DE) 10231335.0

(51) Int. Cl. G06K 9/00

(52) U.S. Cl. 382/165

(57) ABSTRACT

A process for selecting similar colors is disclosed. The process includes the steps of (i) inputting a first color co-ordinates of a first color, and (ii) selecting a color having second color co-ordinates that are similar with respect to the first color co-ordinates, and (iii) displaying a first color area for the first color on a screen, and (iv) displaying a second color areas for the second color on the screen, and (v) selecting one of the second color areas, and (vi) shifting the selected second color area to a region of the first color area to produce a color edge. Also disclosed are a computer program product having programming means for executing the relevant steps and a computer system comprising relevant means.

### FIELD OF THE INVENTION

The invention relates to a method for selecting colors, a corresponding computer program and computer system.

### SUMMARY OF THE INVENTION

A process for selecting similar colors is disclosed. The process includes the steps of (i) inputting a first color co-ordinates of a first color, and (ii) selecting a color having second color co-ordinates that are similar with respect to the first color co-ordinates, and (iii) displaying a first color area for the first color on a screen, and (iv) displaying a second color areas for the second color on the screen, and (v) selecting one of the second color areas, and (vi) shifting the selected second color area to a region of the first color area to produce a color edge. Also disclosed are a computer program product having programming means for executing the relevant steps and a computer system comprising relevant means.

### BACKGROUND OF THE INVENTION

It is known per se from the prior art to identify a specific color uniquely with a color number. Such a color number then serves for example to access the corresponding color in a color catalogue or as a key for accessing relevant information on the color in a database.

This information relating to the color may include for example the color co-ordinates of the color and/or further information such as for example customer information, information regarding the production, in particular the compounding of a polymer, in order to produce a plastics material with the desired color.

The color number is in this connection different from the color co-ordinates of the relevant color: the color number serves simply to identify the color in a number of colors, whereas the color co-ordinates specify the position of a color in a color space (color solid). The CIELAB or another color co-ordinate system may for example be used for this purpose.

There is an unforeseeable number of different colors specifically in the case of products formed from plastics materials. In this connection it is particularly important that a specific product always has the same color in order to guarantee a consistent appearance image. To this end a color number is assigned to such a color of a specific product.

In this connection there is the problem that the color numbers are manufacturer-specific. For example, a customer will therefore generally specify the color of a new product by means of the color co-ordinates of the product and not by a manufacturer-dependent color number. Alternatively the customer will supply the manufacturer with a color sample showing the desired product color. The co-ordinates of the color sample may then be determined by means of a color measuring device.

Various devices for measuring color are known from the prior art. From DE 196 44 616 A1 a color measuring device is known that comprises a light source and a photoelectric cell for receiving the radiation diffusely reflected from the surface of the sample.

A further method and a device for color measurement are known from DE 196 44 617 A1. This method is used to measure the color of a sample of grainy or granular material in a container by determining the diffuse reflection of a measurement beam emitted from the measurement head of the color measuring device onto the surface of the sample.

Various further methods and devices for determining color are known from U.S. Pat. No. 5,526,285, JP-A 0 90 333 49, JP-A 0 72 982 8 1 and FR-A 27 08 105. Color measuring devices are commercially available, for example from Dr. Bruno Lange GmbH, Königsweg 10; 14163 Berlin (www.drlange.de).

The object of the manufacturer is to select, on the basis of the color co-ordinates from the existing product range, a type-color combination that matches the customer's specification as closely as possible. A collection of color samples or a color catalogue is generally accessed for this purpose. This is a rather complicated procedure however on account of the very large number of different colors.

A similar problem also arises with range optimisation. The provision of a complex product range requires a considerable logistic effort and expenditure, plus associated costs. Such complex product ranges exist in various sectors of the economy, in particular in the chemical industry.

On account of the large number of type-color combinations (TCC) of plastics materials particularly complex product ranges have to be handled in this sector, resulting in high complexity costs. In order to reduce these complexity costs an optimized range is sought in order to be able to limit the number of product variants to the necessary degree.

In order to optimize the range an attempt is made for example to convert similar products that have almost the same color to a uniform product. On account of the large number of colors and type-color combinations and the resultant large number of conversion possibilities, such an attempt to simplify the range is also associated with a considerable effort and expenditure.

The object of the present invention is accordingly to provide an improved method for selecting similar colors, as well as an associated computer program product and computer system.

### DESCRIPTION OF THE DRAWINGS

FIG. 1 is a flow diagram of a first embodiment of a method according to the invention,

FIG. 2 is a block diagram of an embodiment of a computer system according to the invention,

FIG. 3 is a schematic representation of the database of the computer system of FIG. 2,

FIG. 4 is a flow diagram of an embodiment for range optimisation,

FIG. 5 is an embodiment of a graphic user interface according to the invention.

### DETAILED DESCRIPTION OF THE INVENTION

The invention enables a computer-assisted preselection of similar colors to be carried out. For this purpose a color is for example specified, for which one or more colors as similar as possible are to be determined. This color may be the specification of a new customer product or a conversion target for optimizing the range.

This color as well as similar colors from the product range are displayed on a screen. Although a precise color representation on the screen is technically possible only to a very limited degree, nevertheless a preselection may efficiently be made in this way so that not all color samples of the similar colors in question have to be compared with the specified color.

In particular it is not necessary to perform such a direct comparison of the color samples for those colors in which the representation on the screen already indicates that they are not sufficiently similar. Only for those colors that appear on the screen representation to be sufficiently similar will the user resort to color samples in order to compare these directly with one another. A considerable saving in time and costs may be achieved by the computer-assisted preselection procedure.

It is particularly advantageous in this connection that individual color areas on the screen may be shifted to the region of the specified color in order to generate a color edge. Such a color edge offers the user the possibility of comparing and contrasting the colors directly in order thereby to decide whether the colors are sufficiently similar or not.

According to a preferred embodiment of the invention the specified color is represented in a central region of a display window in a corresponding color area. In a peripheral region around this color areas are displayed further color areas of similar colors. The user may for example select individual color areas in the peripheral region via a graphic user interface, so that these are shifted automatically to the central color area of the specified colors. In this way corresponding color edges are formed for a direct comparison of the colors.

According to a further preferred embodiment of the invention a three-dimensional color co-ordinate system, such as for example the LAB system, is used to input color co-ordinates and to select similar colors. On the other hand another color co-ordinate system, such as for example the RGB system, is used to display the corresponding colors on the screen. For the display on the screen the LAB color co-ordinates must therefore be converted to the RGB color co-ordinate system. Methods for transforming color co-ordinates between various color co-ordinate systems are known for example from U.S. Pat. Nos. 6,108,442 and 6,137,596.

According to yet another preferred embodiment of the invention a similarity quantity is used for the selection of similar colors. The Euclidean distance between the color co-ordinates in the color space is preferably used as similarity quantity. In addition further product properties may also be involved in the similarity quantity.

Preferred embodiments of the invention are described in more detail hereinafter with reference to the accompanying drawings, in which:

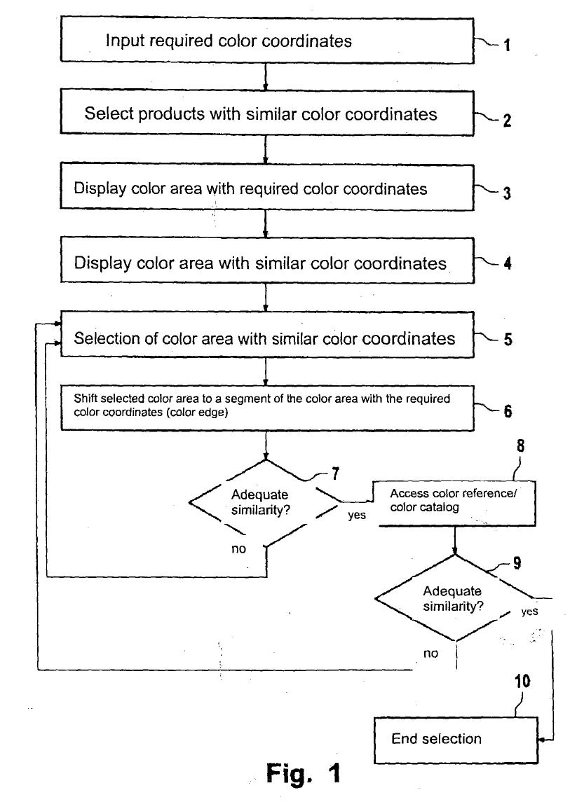

FIG. 1 is a flow diagram of a first embodiment of a method according to the invention,

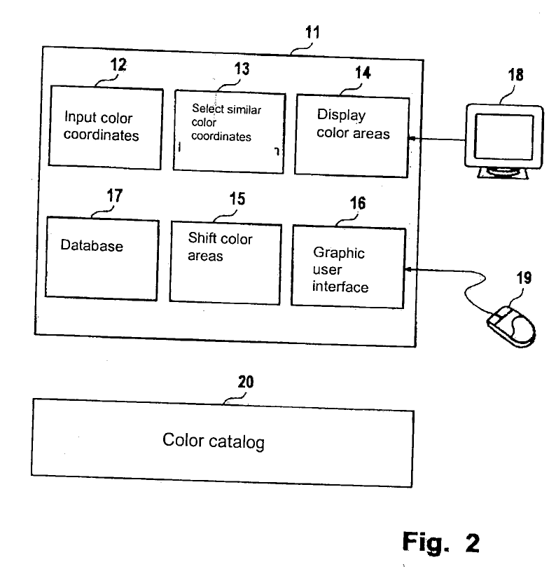

FIG. 2 is a block diagram of an embodiment of a computer system according to the invention,

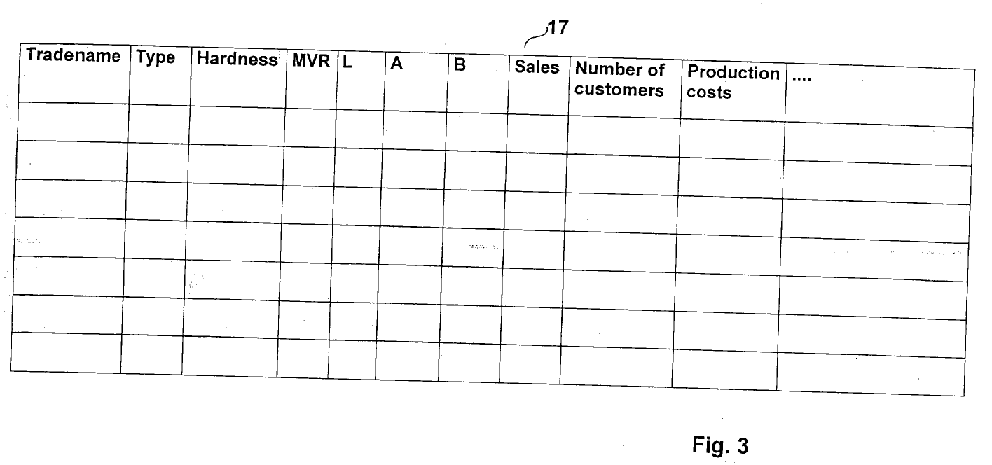

FIG. 3 is a schematic representation of the database of the computer system of FIG. 2,

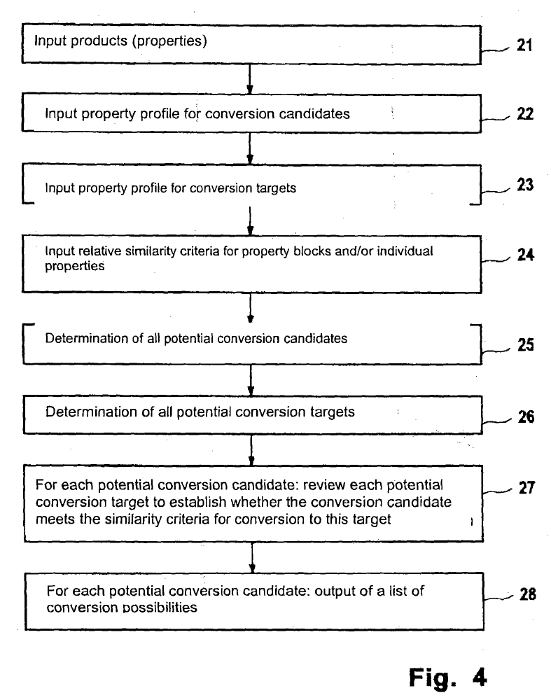

FIG. 4 is a flow diagram of an embodiment for range optimisation,

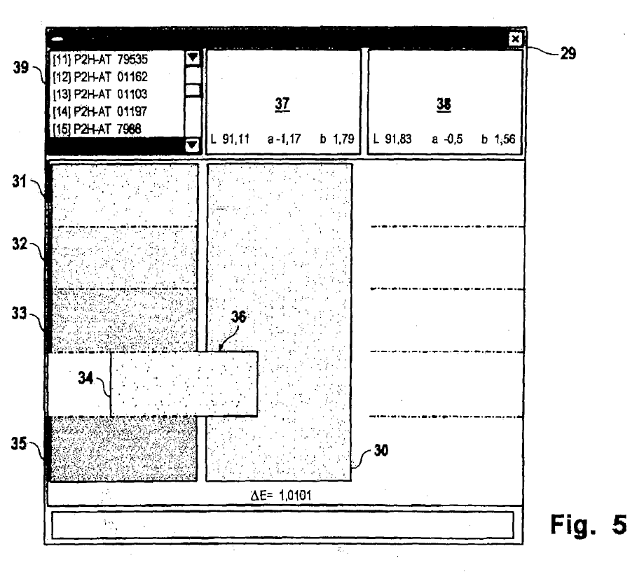

FIG. 5 is an embodiment of a graphic user interface according to the invention.

FIG. 1 shows a flow diagram of a method for selecting similar colors. In step 1 the input of the color co-ordinates of a desired color takes place. These may include for example the color co-ordinates of a color sample that a customer has supplied for the specification of the color of a new product. The object is then to determine products with as similar colors as possible from the manufacturer's range.

Another possible application is range optimisation. In this case the color co-ordinates of the conversion candidates are input as the desired color co-ordinates. This should then be compared with various possible conversion targets of similar colors. The generation of such conversion candidates and conversion targets is described in more detail hereinafter with reference to FIG. 4.

In step 2 there takes place a selection of products with similar color co-ordinates. This may be performed by accessing a database of the manufacturer containing product information. This database also includes the color co-ordinates of the respective products. Products are then searched for in this database that have a color distance to the desired color co-ordinates that is less than a predetermined threshold value. The Euclidean distance of the color co-ordinates in the color co-ordinate system may be used as color distance. In addition to the color co-ordinates, further product properties may also be involved in the selection. This is particularly the case in range optimisation.

In step 3 a color area with the desired color co-ordinates is displayed on a screen. For this purpose it is necessary, depending on the circumstances, to convert the color co-ordinates first of all into a color co-ordinate system that is used by the relevant computer system. In step 4 color areas for the similar color co-ordinate system determined in step 2 are also correspondingly displayed on the screen.

In step 5 the user selects one of the color areas with similar color co-ordinates, for example via a graphic user interface by clicking on with a mouse. The selected color area is then “shifted” over the color area with the desired color co-ordinates so as to form a color edge. With the aid of this color edge the user may in step 7 assess particularly well whether the comparison colors are sufficiently similar or not.

If the user comes to the conclusion that there is not a sufficient degree of similarity, then he returns to step 5 in order to select a further color area with similar color co-ordinates. If the user however finds a sufficient similarity, then in step 8 he accesses a color sample. This access may be performed automatically or manually.

The user may then directly compare a color sample of the color with the desired color co-ordinates with a color sample of the similar color selected in step 5. This direct visual comparison preferably takes place under a standard light device in step 9.

If the user establishes that, as a result of the direct visual comparison, there is still not a sufficient degree of similarity, then he will perform step 5 again in order to select a further color. If however the direct visual comparison also shows a sufficient degree of similarity, then the selection may be ended in step 10.

FIG. 2 shows a block diagram of a corresponding computer system 11. The computer system 11 may be a commercially available personal computer. The computer system 11 comprises a program module 12 for inputting color co-ordinates (see step 1 of FIG. 1), a program module 13 for selecting similar color co-ordinates (see step 2 of FIG. 1), a program module 14 for displaying color areas (see steps 3 and 4 of FIG. 1) as well as a program module 15 for displacing selected color areas (see step 6 of FIG. 1). The computer system 11 has a graphic user interface 16 as well as a database 17. The database 17 may be connected to another computer, for example to a database server computer; in this case the computer system 11 has a corresponding connection to the external database.

The computer system 11 includes in addition a screen 18 as well as a mouse 19.

A color catalogue 20 with color samples of the manufacturer's range is also provided. This color catalogue 20 may be accessed either manually by the user or automatically by the computer system 11; in the latter case the computer system 11 relieves the user of manually searching for a desired color sample in the color catalogue 20.

During operation of the computer system 11 the desired color co-ordinates are first of all input via the program module 12. Products with similar color co-ordinates are then determined from the database 17 by means of the program module 13.

The program module 14 then generates an output with color areas for the color having the desired color co-ordinates as well as color areas for the colors with the similar color co-ordinates determined by the program module 13. These color areas are shown on the screen 18.

The user may access these color areas via the graphic user interface 16, for example by means of the mouse 19. If the user selects one of the color areas for example by clicking on with the mouse 19, then this is automatically shifted by means of the program module 15 over the color area of the color having the desired color co-ordinates, so that a color edge is formed for the purposes of comparing the colors on the screen 18.

If the user establishes a sufficient degree of similarity of the colors displayed on the screen, then depending on the particular modification he may access the color catalogue 20 either manually in order to retrieve the corresponding color sample manually, or may access the color catalogue 20 automatically by means of the computer system 11 after he has input a corresponding request in the computer system.

FIG. 3 shows an embodiment of the database 17 for storing a product range.

Each line in the database 17 refers to a product of the range, which is characterised by its product identification, such as for example its trade name. One or more of the properties of the product together with the trade name are stored in the relevant line of the database entry of the database 17.

These properties may include for example mechanical properties of the product, processing properties and processing parameters of the product, as well as commercial properties. Examples of mechanical properties are ISO-ak (notch-impact strength) and hardness. Examples of processing-related properties are MVR (flowability), Vicat stability (dimensional stability under heat) and the shrinkage. Examples of commercial properties of the product are the sales volume, turnover, the number of customers, as well as the manufacturing costs.

A particularly important property of a commercial product is its color. The color is described by specifying the co-ordinates of the color of the plastics material in a color space. The LAB co-ordinates of the CIELAB color space for example may be used for this purpose. As regards the color, it is furthermore advantageous to specify a color number, color tolerances as well as possibly diffuse reflection curves.

Furthermore the database 17 includes for each product the type of product, in addition to the trade name. The type specification characterises certain special properties of the relevant commercial product. With types a distinction is made for example between properties such as “readily flowing”, “thermally stabilised”, “medium viscosity”, “additionally nucleated”, “stabilised against weathering”, “relatively high viscosity”, “glass fibre proportion”, “flameproofed”, etc.

On account of the large number of possible variations, in particular of the type-color combinations, the database 17 of a plastics product range may contain several hundred to several thousand different products.

FIG. 4 shows the determination of conversion candidates and conversion possibilities for simplifying the range, for example of a plastics product range, such as is stored in the database 17 in FIG. 3.

In step 21 the products of the product range are input together with the properties associated with the products. In this way a database is established, for example in the form of the database 17 of FIG. 3.

In step 22 a property profile for conversion candidates is input. The term “conversion candidate” is understood hereinafter to denote a product that is suitable for the range simplification, in other words conversion to another product. In order to be considered at all as a conversion candidate, the relevant product must satisfy a property profile that may be defined by the user. Such a property profile may consist of one or more properties.

In step 23 a property profile for conversion targets is input. The term “conversion target” is understood in this context to denote a product of the product range that is suitable as a replacement for a conversion candidate. A conversion target is thus a product that may replace one or more of the products of the range since it is sufficiently similar to these products.

In order to be considered at all as a conversion target, it is necessary for the relevant product to satisfy a specific property profile. This property profile may be defined by the user and includes one or more properties that the product must satisfy in order to be classified as a conversion target.

In step 24 relative similarity criteria between property blocks or individual properties are input, which have to be satisfied in order that a conversion candidate may be classed as sufficiently similar to a conversion target. The property blocks are composed of several properties, such as for example the color co-ordinates or other properties, that belong to a common category.

In step 25 a database search of the database 17 (see FIG. 3) is started using the property profile of the step 22 as search criterion, in order to determine all possible conversion candidates of the database that correspond to the property profile. In step 26 a search is conducted for the conversion targets in the database 17, the property profile of the step 23 being used as search parameter.

In step 27 one of the conversion candidates is tested to see whether one of the conversion targets that had been determined in step 26 satisfies the similarity criteria of step 24. If this is the case, the relevant conversion target is an actual conversion possibility.

This test is repeated as regards this conversion candidate for each conversion target in order to obtain thereby a number of conversion possibilities for the conversion candidates. Step 27 is carried out with respect to each of the conversion candidates determined in step 25 in order to obtain no, one or more conversion possibilities for each conversion candidate.

These conversion possibilities are output for example in the form of a list for each conversion candidate. These lists preferably also include the relevant properties of the conversion possibilities in order to be able to make a selection from the list for a conversion of the conversion candidates to a product of the list of conversion possibilities.

These results are then used as a basis for the range simplification, by inputting the color co-ordinates of the conversion candidates as desired color co-ordinates (see step 1 of FIG. 1), and the color co-ordinates of the conversion possibilities are input as the selection of products with similar color co-ordinates in step 2 (see FIG. 1).

An example of the representation of the various color areas on the screen 18 is shown in FIG. 5.

A window 29 is displayed on the screen (see screen 18 of FIG. 2). In a central region of the window 29 is displayed a color area 30 that corresponds to the desired color co-ordinates, in other words depending on the specific application corresponds to the color desired by the customer or to the conversion candidates for the range optimisation.

Further color areas 31 to 35 are displayed around the periphery of the color area 30, which in each case correspond to a color having color co-ordinates similar to the color of the color area 30. The user may select a similar color by clicking on one of the color areas 31 to 35.

This is then shifted from its primary position to the color area 30 so as to form a color edge. If the user selects for example the color area 34, then this is shifted to the color area 30, as is shown for example in FIG. 5. In this way a color edge 36 is formed between the color areas 34 and 30.

The color co-ordinates of the color area 30 are displayed in a display region 37 of the window 29; in addition the color co-ordinates of the selected color area—in the illustrated example the color area 34—are displayed in a display region 38. Furthermore the Euclidean distance ΔE between the color co-ordinates of the color area 30 and the color co-ordinates of the selected color area, i.e. the color area 34 and the color area 30, is also displayed. In addition to this the product names/identifications of the comparison products are displayed in the display region 39 of the window 29.

Reference Numeral List

| | |
|---|---|
| Computer system | 11 |
| Program module | 12 |
| Program module | 13 |
| Program module | 14 |
| Program module | 15 |
| Graphic user interface | 16 |
| Database | 17 |
| Screen | 18 |
| Mouse | 19 |
| Color catalogue | 20 |
| Window | 29 |
| Color area | 30 |
| Color area | 31 |
| Color area | 32 |
| Color area | 33 |
| Color area | 34 |
| Color area | 35 |
| Color edge | 36 |
| Display region | 37 |
| Display region | 38 |
| Display region | 39 |

Although the invention has been described in detail in the foregoing for the purpose of illustration, it is to be understood that such detail is solely for that purpose and that variations may be made therein by those skilled in the art without departing from the spirit and scope of the invention except as it may be limited by the claims.

What is claimed is:

1. A process for selecting similar colors comprising the steps of
(i) inputting a first color co-ordinates of a first color, and
(ii) selecting a color having second color co-ordinates that are similar with respect to the first color co-ordinates, and
(iii) displaying a first color area for the first color on a screen, and (iv) displaying a second color areas for the second color on the screen, and
(v) selecting one of the second color areas, and
(vi) shifting the selected second color area to a region of the first color area to produce a color edge.

2. The process according to claim 1 wherein the displaying of first color area is in a central region of a display window and the displaying of the second color areas is in a peripheral region around the first color area.

3. The process according to claim 1 wherein the first and second color co-ordinates belong to a first color co-ordinate system and the display of the first and second color areas on the screen is based on a second color co-ordinate system and the first and second color co-ordinates of the first color co-ordinate system are converted into corresponding first and second color co-ordinates of the second color co-ordinate system.

4. The process according to claim 3, wherein the first color co-ordinate system is the CIELAB co-ordinate system and the second color co-ordinate system is the RGB system.

5. The process according to claim 1 wherein step (ii) is made on the basis of a similarity quantity that is compared to a predetermined threshold value.

6. The process according to claim 5, wherein a Euclidean distance between the first and second color co-ordinates in the first color co-ordinate system is used as similarity quantity.

7. The process according to claim 5 wherein the similarity quantity includes product properties and interspaced color co-ordinates.

8. The process according to claim 1 wherein step (v) is carried out via a graphic user interface.

9. The process according to claim 1 wherein a color sample of a second color evaluated by the user as sufficiently similar is accessed in order to compare the color sample directly with a color sample of the first color.

10. A computer program product having programming means for executing the following steps:
(i) inputting a first color co-ordinates of a first color,
(ii) selecting a color with second color co-ordinates that are similar with respect to the first color co-ordinates,
(iii) displaying a first color area for the first color on a screen,
(iv) displaying second color areas for the second color on the screen,
(v) selecting of one of the second color areas,
(v) automatically shifting the selected second color area to a region of the first color area to produce a color edge.

11. The product according to claim 10, wherein the first color area is displayed in a central region of a display window and wherein the second color areas are displayed in a peripheral region of the first color area.

12. The product according to claim 10, further comprising the means to convert the color co-ordinates of a color from a first co-ordinate system to a second system.

13. The product according to claim 10 wherein the first color co-ordinate system is the CIELAB co-ordinate system and the second system is the RGB system.

14. The product according to claim 10 wherein step (ii) is carried out on the basis of a similarity quantity that is compared to a predetermined threshold value.

15. The product according to claim 14 wherein a Euclidean distance between the first and second color co-ordinates in the first color co-ordinate system is used as similarity quantity.

16. The product according to claim 14 wherein the similarity quantity includes product properties and interspaced color co-ordinates.

17. The product according to claim 10 wherein step (v) is carried out via a graphic user interface.

18. A computer system comprising
(i) means for inputting first color co-ordinates of a first color,
(ii) means for inputting second color co-ordinates of a second color, the second color co-ordinates being similar to the first co-ordinates,
(iii) means for displaying a first color area for the first color on a screen,
(iv) means for displaying second color areas for the second colors on the screen,
(v) means for inputting a selection of one of the second color areas,
(vi) means for automatically shifting the selected second color area to a region of the first color area to produce a color edge.

19. The computer system according to claim 18, wherein the displaying of the first color area is in a central region of a display window and the displaying of the second color areas is in a peripheral region of the first color area.

20. The computer system according to claim 18 further comprising means for converting the co-ordinates of a first color system to second system.

21. The computer system according to claim 20 wherein the first color system is the CIELAB co-ordinate system and the second system is the RGB system.

22. The computer system according to claim 18 wherein (ii) is made on the basis of a similarity quantity that is compared to a predetermined threshold value.

23. The computer system according to claim 22, wherein a Euclidean distance between the first and second color co-ordinates in the first color co-ordinate system is used as similarity quantity.

24. The computer system according to claim 22 wherein the similarity quantity includes product properties and interspaced color co-ordinates.

25. The computer system according to claim 18 wherein (v) is carried out via a graphic user interface.
